(19) United States
(12) Patent Application Publication
(10) Pub. No.: US 2013/0091772 A1
(43) Pub. Date: Apr. 18, 2013

(54) ICE DISPENSING APPARATUS WITH A SHAPE MEMORY ALLOY ACTUATOR

(71) Applicants: Justin BERGER, Louisville, KY (US); Jedediah Taylor DAWSON, Crestwood, KY (US)

(72) Inventors: Justin BERGER, Louisville, KY (US); Jedediah Taylor DAWSON, Crestwood, KY (US)

(21) Appl. No.: 13/273,259

(22) Filed: Oct. 14, 2011

(51) Int. Cl. F25C 5/16; E05F 15/18

(52) U.S. Cl. 49/324

(57) ABSTRACT

An apparatus includes a duct door rotatably mounted in relation to an ice dispenser recess, and a selectively energizable shape memory alloy wire coupled to the duct door such that the shape memory alloy wire causes the duct door to rotate between its open and closed positions, when the wire is energized and de-energized respectively. A method of using an apparatus is also disclosed.

### BACKGROUND OF THE INVENTION

The subject matter disclosed herein relates generally to refrigeration, and more particularly to ice dispensers and the like.

It is now common practice in the art of refrigerators to provide an automatic icemaker. The icemaker is often disposed in a freezer compartment and ice is often dispensed through an opening in the access door of the freezer compartment. In this arrangement, ice is formed by freezing water with cold air in the freezer compartment.

In general, a duct door separates an ice chute from the outside of a unit, and a mechanism is needed to open the duct door so that ice can freely pass, as well as to subsequently close that chute so that air does not leak out once the ice has been dispensed.

Existing approaches include a solenoid, which is a linear actuator that is connected to a crank, whereby the solenoid helps to turn that crank and close it back shut. Other approaches include one-way AC motors with cams, one-way DC motors with cams, reversible DC motors with gear systems, and manual actuation by linkages from a paddle.

### BRIEF DESCRIPTION OF THE INVENTION

As described herein, the exemplary embodiments of the present invention overcome one or more disadvantages known in the art.

One aspect of the present invention relates to an apparatus comprising a duct door rotatably mounted in relation to a refrigerator dispenser recess, and a shape memory alloy wire coupled to the duct door such that the shape memory alloy wire causes the duct door to rotate.

Another aspect of the present invention relates to a method comprising the steps of: applying a voltage to a refrigerator duct door actuator in response to a first signal from a refrigerator dispenser switch to open the duct door, wherein the voltage heats a shape memory alloy wire in the duct door actuator, causing the shape memory alloy wire to contract in size, thereby causing the duct door to open, and removing at least a portion of the voltage from the refrigerator duct door actuator in response to a second signal from the refrigerator dispenser switch to close the duct door, wherein the voltage removal allows the shape memory alloy wire to cool and expand in size, thereby causing the duct door to close.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 is a perspective view of an exemplary “bottom freezer” refrigerator;

FIG. 2 is a simplified, perspective view of the refrigerator of FIG. 1 with the access doors of the fresh food compartment being in an open position and the drawer for the freezer compartment being removed for clarity;

FIGS. 3A and 3B show an example of a shape memory alloy (SMA) actuator, according to an aspect of the invention;

FIG. 4 is another example shape memory alloy (SMA) actuator, according to an aspect of the invention;

FIGS. 5A and 5B show another example actuator in a refrigerator apparatus, according to an aspect of the invention;

FIG. 6 is a block diagram of an example duct door assembly, according to an aspect of the invention;

FIG. 7 is a block diagram of an example actuator assembly, according to an aspect of the invention;

FIG. 8 is a flow chart of a method for operating an example actuator, in accordance with a non-limiting aspect of the invention; and

FIG. 9 is a block diagram of an exemplary computer system useful in connection with one or more embodiments of the invention.

### DETAILED DESCRIPTION OF THE EXEMPLARY EMBODIMENTS OF THE INVENTION

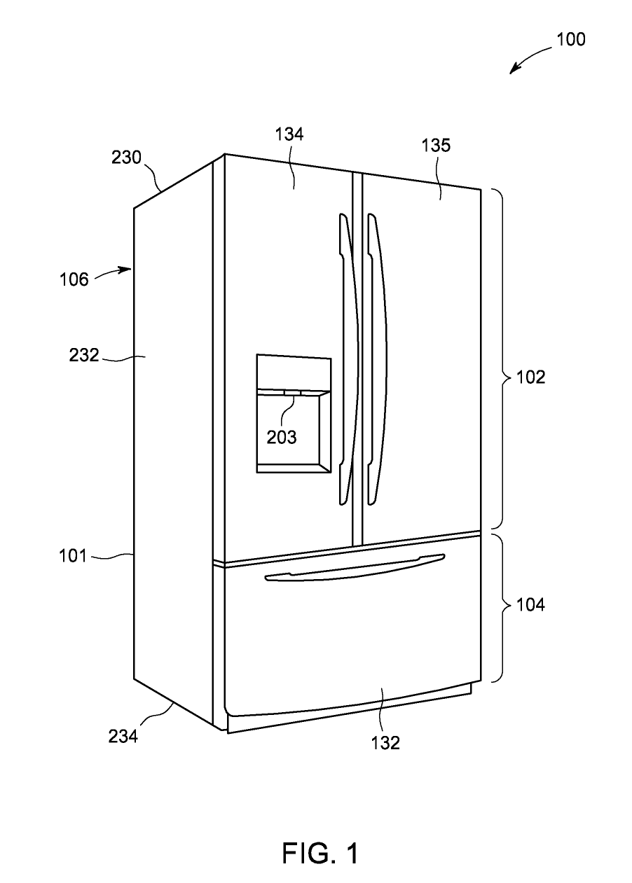

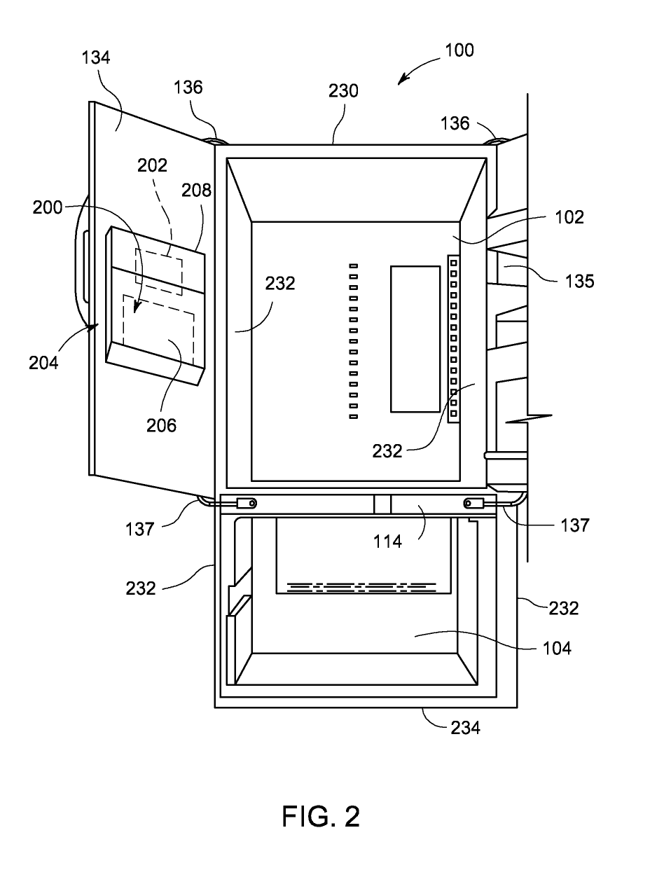

FIG. 1 and FIG. 2 illustrate an exemplary refrigerator 100 which includes a fresh food compartment 102 and a freezer compartment 104. The refrigerator 100 is coolable by a conventional vapor-compression temperature control circuit. Although the refrigerator 100 is shown as the “bottom freezer” type, the teaching of the description set forth below is applicable to other types of refrigeration appliances, including but not limited to, side-by-side refrigerators. The present disclosure is therefore not intended to be limited to any particular type or configuration of a refrigerator.

The freezer compartment 104 and the fresh food compartment 102 are arranged in a bottom mount configuration where the freezer compartment 104 is disposed or arranged beneath or below the fresh food compartment 102. The fresh food compartment 102 is shown with French doors 134 and 135. However, a single access door can be used instead of the French doors 134, 135. The freezer compartment 104 is closed by a drawer or an access door 132.

The fresh food compartment 102 and the freezer compartment 104 are contained within a main body including an outer case 106 (as well as back 101). The outer case 106 can be formed by folding a sheet of a suitable material, such as pre-painted steel, into a generally inverted U-shape to form a top 230 and two sidewalls 232 of the outer case 106. A mullion 114, which is shown in FIG. 2 and is for example formed of an extruded ABS material, connects the two sidewalls 232 to each other and separates the fresh food compartment 102 from the freezer compartment 104. The outer case 106 also has a bottom 234, which connects the two sidewalls 232 to each other at the bottom edges thereof, and the back 101. As is known in the art, a thermally insulating liner is affixed to the outer case 106.

The access door 132 and the French doors 134, 135 close access openings to the freezer compartment 104 and the fresh food compartment 102, respectively.

Each French door 134, 135 is mounted to the main body by a top hinge 136 and a corresponding bottom hinge 137, thereby being rotatable about its outer vertical edge between an open position for accessing the respective part of the fresh food compartment 102, as shown in FIG. 2, and a closed position for closing the respective part of the fresh food compartment 102, as shown in FIG. 1.

Similarly, when an access door 132 is used for the freezer compartment 104, it is rotatably attached to the main body in a known fashion. When a drawer is used for the freezer compartment, it is slidably received in the cavity defined by the sidewalls 232, the mullion 114 and the bottom 234 in a known fashion.

As illustrated in FIG. 2, an ice making and storage assembly 200 is mounted on the interior surface of the access door 134 of the fresh food compartment 102 (of course, the ice making and storage assembly 200 can be mounted on the access door 135 instead). The ice making assembly 200 includes a thermally insulated ice compartment 204 mounted or formed on the access door 134, and an icemaker 202 disposed in the ice compartment 204 (alternatively, the icemaker 202 may be disposed in the freezer compartment 104 and connected to or in communication with the ice compartment 204 through a channel). Water is provided to ice molds of the icemaker 202 through a water supply conduit (not shown) extending from the main body of the refrigerator to the icemaker 202, and then is frozen into ice cubes. Then the ice cubes are usually discharged from the icemaker 202 and stored in an ice storage bin 206 until needed by a user. The ice storage bin 206 is disposed in the ice compartment 204, below the icemaker 202. The ice cubes may be withdrawn by accessing the ice compartment 204 through an access door 208 which faces the fresh food compartment 102 when the access door 134 is closed. However, the ice cubes are typically withdrawn by using an ice dispenser (not shown) installed in the access door 134 through an opening 203 (shown in FIG. 1) formed on the exterior surface of the French door 134. The opening 203 faces away from the fresh food compartment 102 when the access door 134 is closed and is formed at a height facilitating convenient access to the ice. These are known in the art and therefore will not be discussed in detail here.

As described herein, one or more embodiments of the invention include a shape memory alloy (SMA) mechanism used in refrigerator ice dispenser duct door opening and closing. As also detailed herein, one aspect of the invention includes using shape memory alloy wire to open a refrigerator ice dispenser duct door against a biasing device such as a spring or counterweight which is used to close the door when the SMA was not activated.

Shape memory alloy wire has electrical resistance that produces heat when a voltage is applied. Phase changes in the alloy allow for shape change as the material changes temperature. For example, applied electricity would produce heat which would cause the wire to contract length-wise, thus opening the door. Accordingly, as detailed herein, a contracting loop of wire can be used to produce a linear displacement.

The mechanism described in connection with one aspect of the invention would require lower costs than solenoids or motors used in existing approaches to move a door. Additionally, the shape memory alloy mechanism would not require position detection or reversible polarity, as are needed by some motors. The motion of the door would be quieter than the solenoid, which audibly snaps open and closed caused by rapid displacement without an additional dampening device. The space required for the shape memory alloy is smaller than existing approaches and offers flexibility in mounting configuration. Further, in one embodiment of the invention, a shape memory alloy wire can be used in conjunction with a biasing device to close a door as the supply is deactivated.

As described herein, an aspect of the invention includes a linear actuator. In contrast to existing approaches that, for example, use a coil of wire, which can be costly and raise size concerns—a solenoid, for instance, uses a thick copper coil that creates a magnetic field which pulls a pin—the shape memory alloy detailed herein includes just one loop of wire. In an example embodiment of the invention, a 5-inch loop of wire is used. It should be noted, however, that longer loops can create greater displacement to provide equivalent torque with reduced forces. Wire of varying lengths is generally available from 0.001-0.250 thickness, though often most cost-effect in smaller gages. As a voltage is applied across the wire, the wire heats up (with natural resistance of the wire) and contracts; that is, the length of the wire reduces and that lift is used as a linear actuator to pull a crank and open the door. By way of example, in one embodiment of the invention, the wire contracts by 4%. This percentage, typically ranging from 2-5%, is an intrinsic property associated with the phase change of the material reached upon crossing a given temperature threshold.

In one or more example embodiments of the invention, a shape memory alloy wire can be composed of nitinol, nickel-titanium, copper, zinc, aluminum, nickel, gold, cadmium, iron, manganese, silicon, or combinations thereof which can be alloyed with other metals. Further, in one aspect of the invention, the shape memory alloy can be encased in a tube to protect the wire from any contact as well as to serve as a guide to help guide the linear displacement along the correct axis.

As described herein, the operation of the shape memory alloy is on consumer demand. That is, the user would activate a switch or a paddle on the refrigerator apparatus and that would activate the actuator to open the duct door. Accordingly, activating the switch or paddle would activate the voltage to heat the wire. This action can be carried out, for example, via sending the switch signal to a control board that actuates the wire, or via having the switch close the circuit and power-up the actuator.

As also detailed herein, an aspect of the invention utilizes a lower holding power than existing approaches. For example, the shape memory alloy, in one embodiment, can open at around 9 watts and step down to 5 watts. In another example embodiment that utilizes a lower holding voltage, the shape memory alloy can open at around 8 volts and step down to 5-6 volts.

As such, according to an example embodiment of the invention, when a consumer presses in a relevant tab or engages a switch on the refrigerator apparatus, voltage is applied to the shape memory alloy wire, the wire contracts, and opens the door to the chute. By way of example, a tab can release a spring-biased lid to open as the shape memory alloy pulls to deflect an arm. As noted, the shape memory alloy contracts, pulling up on a member that is attached to and rotates the door open. Such a mechanism can also include a fixed pin about which the duct door rotates. Then, when the consumer releases the tab or disengages the switch, the voltage is decreased, and the wire returns to original length and closes the door.

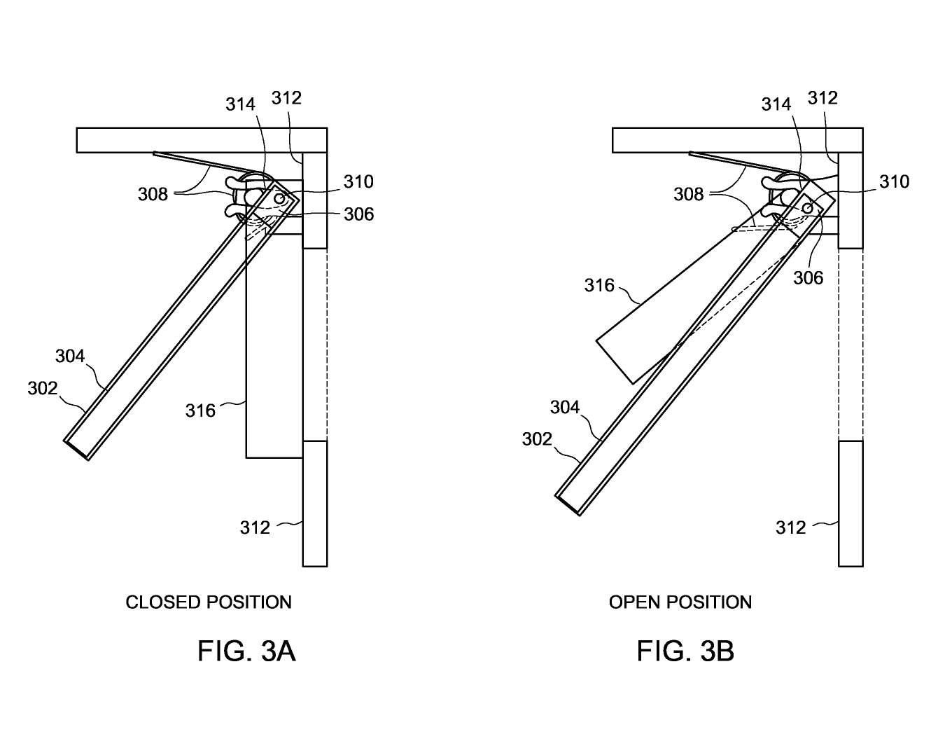

FIGS. 3A and 3B schematically show a shape memory alloy (SMA) actuator, according to an aspect of the invention. By way of illustration, FIGS. 3A and 3B depict a tube encasing 302 for a shape memory alloy actuator, the SMA wire 304, a slider 306 and a biasing spring 308. FIGS. 3A and 3B also depict a crank pin 310, recess 312, crank 314 and duct door 316 which is fixedly attached to or disposed relative to the crank 314. The SMA wire 304 is disposed in the tube encasing 302, with its lower end being attached, for example, to the tube encasing 302, and its upper end engaging or being attached to the slider 306. The slider 306 is also disposed in the tube encasing 302 and engages the crank pin 310. The crank pin 310 connects the crank 314 to the slider 306. The crank pin 310 is rotatable at least with respect to one of the crank 314 and the slider 306. Moreover, the crank pin 310 is radially offset from the rotational axis of the duct door 316. The slider 306 provides an interface between the SMA wire 304 and crank pin 310 and guides movement by sliding in a linear direction. More specifically, when electricity is applied to the SMA wire 304, it contracts length-wise, which contraction, as shown in FIG. 3B, causes the slider 306 to move downward along the length of the tube encasing 302, which in turn causes the crank 314 to rotate clockwise (as illustrated in FIG. 3B) relative to the rotational axis of the duct door 316. The clockwise rotation of the crank 314 causes the duct door 316 to rotate clockwise to an open position (FIG. 3B) so that ice can be dispensed. The biasing spring 308, a torsion spring in this example embodiment, provides a constant torque to hold the duct door 316 in the closed position (FIG. 3A) when ice is not being dispensed.

The recess 312 provides a barrier between insulating foam inside the door and the external of the unit, as well as a surface for the actuator and duct door 316 to mount. When the SMA wire 304 contracts, the slider 306 is linearly pulled within the stationary tube encasing 302, and the crank pin 310 is pulled in an arc tangent to the crank 314. The travel of the crank pin 310 along said arc rotates the duct door 316 along the center axis of the crank 314. As the SMA wire 304 expands, the slider 306 returns to the original position allowing the crank pin 314 to move along the returning arc path and the duct door crank 314 and duct door 316 to rotate to the closed position. The duct door 316 seals against the recess 312 when ice is not being dispensed and rotatably opens about the crank 314 to open for dispensing.

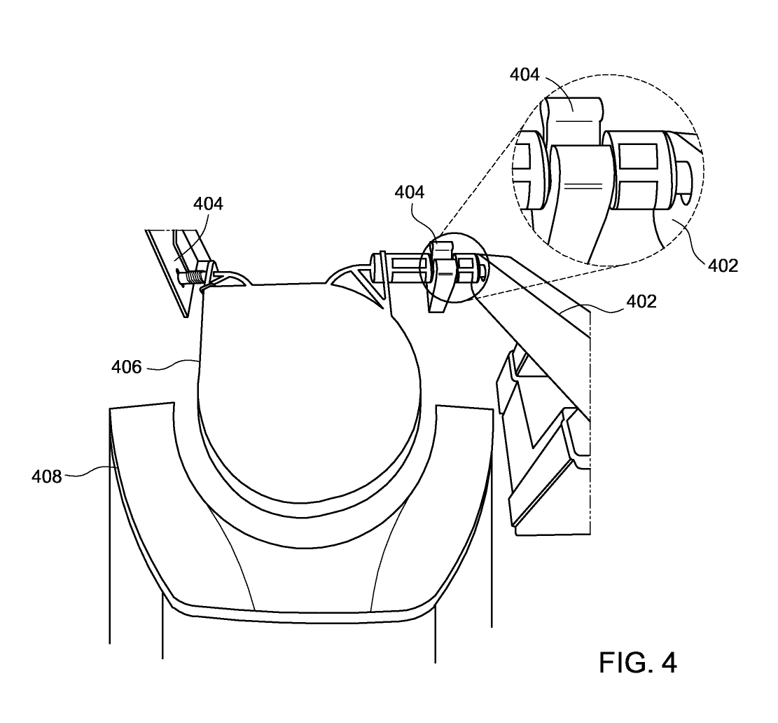

FIG. 4 is an example shape memory alloy (SMA) actuator 402, according to an aspect of the invention. By way of illustration, FIG. 4 depicts mounting features 404, duct door 406 and ice funnel 408. The duct door 406 has an integrated crank which is rotatably supported by mounting feature 404. When the actuator 402 linear displaces a pin on the integrated crank of the duct door 406, the duct door 406 rotates to open and ice passes through the door opening and is guided by the ice funnel 408 to be dispensed to the consumer.

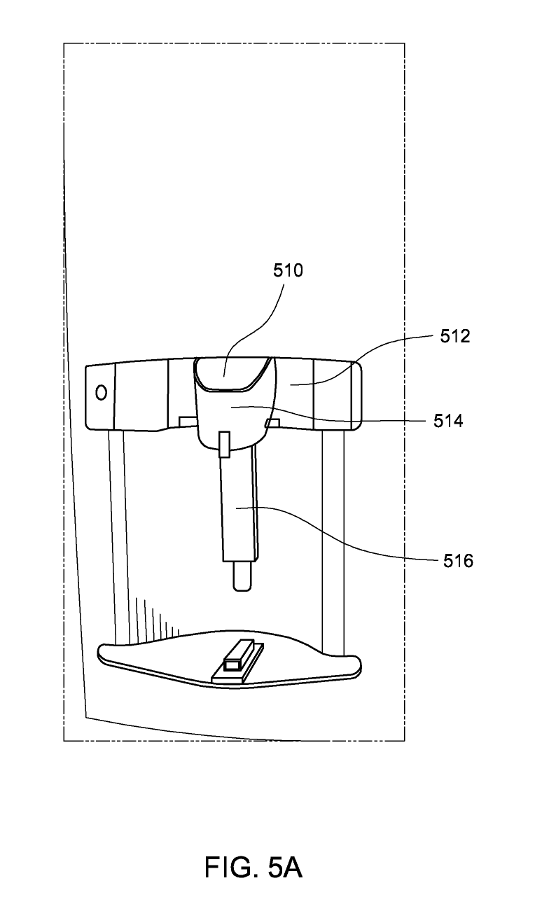

FIGS. 5A and 5B show an example actuator in a refrigerator apparatus, according to an aspect of the invention. By way of illustration, FIG. 5B is a schematic, back view of a door of the refrigerator apparatus, depicting an ice maker 502 disposed in an ice compartment 505 on the door, the opening of an ice chute 508 at the bottom of the ice compartment 505, an ice storage bin 504 which is removed from the ice compartment 505, an auger 506a in the ice storage bin 504 and a motor 506b which is in the ice compartment 505 and engages the auger 506a when the ice storage bin 504 is properly positioned in the ice compartment 505. FIG. 5A is a schematic, front, partially exposed view of the door, depicting an actuator mounting region 512, an ice funnel 514 and a paddle 516. The paddle 516 can contain a switch, which the user presses with a drinking vessel or with his/her hand to dispense water or ice. Additionally, the actuator can have features integrated for mechanical fastening to the mounting region 512 with screws or snaps that positively locate the actuator to the duct door 510.

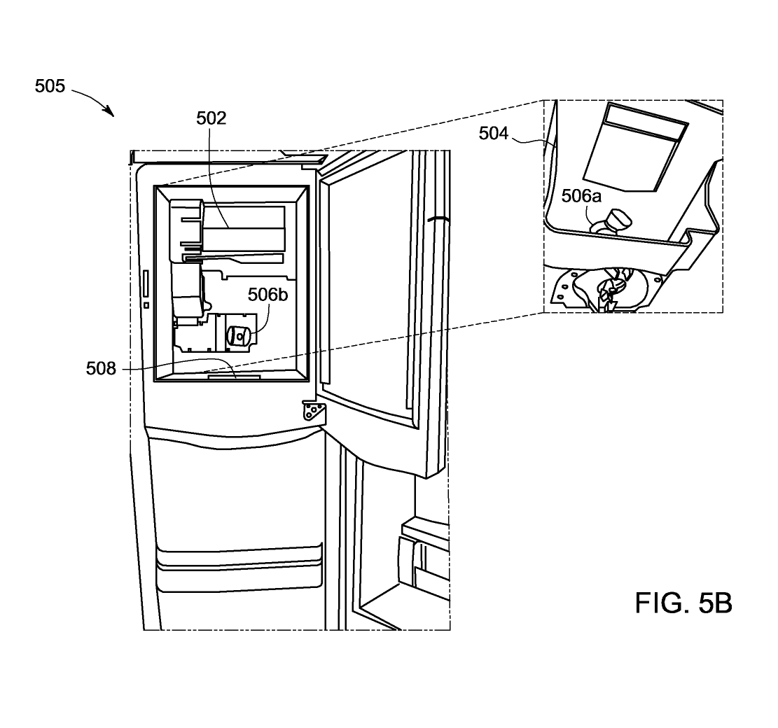

FIG. 6 is a block diagram of an example duct door assembly, according to an aspect of the invention. By way of illustration, FIG. 6 depicts a dispenser control board 602 and a paddle assembly 604. The paddle assembly 604 provides an actuation point and sends the control board 602 a signal to initiate or stop dispensing. The dispense control board 602 sends a signal to the actuator 608 to begin, maintain and/or stop dispensing. The control board 602 also provides power and control to recess and duct door heaters, sends power to the switch/paddle 604, and also receives a signal from the switch/paddle 604 to initiate or stop dispensing.

FIG. 6 also depicts a duct door assembly 606, which includes a duct door actuator 608, a duct door body 610, a duct door insulation component 612, a duct door gasket 614 and a duct door spring 616. As noted, the duct door spring 616 rests on the duct door body 610, and the duct door gasket 614 rests on the duct door insulation component 612 and wraps around the duct door body 610. The duct door insulation component is inserted and adhered to (via adhesive) the duct door body 610. The duct door actuator 608 is inserted into the duct door body 610 and screws onto the dispenser recess 618. Additionally, the duct door body 610 snaps into the dispenser recess.

The duct door actuator 608 interacts with the dispenser control board 602 and operates the duct door for ice delivery against spring force. The duct door body 610 provides alignment and a rotation axis for the duct door assembly, and also provides a lip for assembling the gasket. Additionally, the duct door body 610 contains and protects the insulation, retains the spring in position, and transfers actuator force to torque through the duct door assembly. The duct door insulation component 612 provides a thermal barrier between an ice compartment and ambient, and also supports the duct door gasket 614 position. Further, the duct door gasket 614 seals an ice opening on the recess to prevent airflow. Also, the duct door spring 616 provides torque to close the duct door assembly 606 and force the gasket against the recess for a seal.

FIG. 6, as illustrated, also depicts a dispenser recess 618, a recess heater 620 and a funnel 622. The funnel 622 snaps into the recess 618, while the recess heater 620 adheres (via an adhesive) to the recess 618. Additionally, the dispenser recess 618 provides attachment points for the duct door 610, the spring 616, the actuator 608 and the funnel 622. Also, the recess 618 restricts the actuator base from rotating. The recess heater 620 warms the recess around the ice dispense passage, preventing moisture condensation. Additionally, the funnel 622 guides ice cubes into the container, preventing breakage, and also allows clearance for opening the duct door.

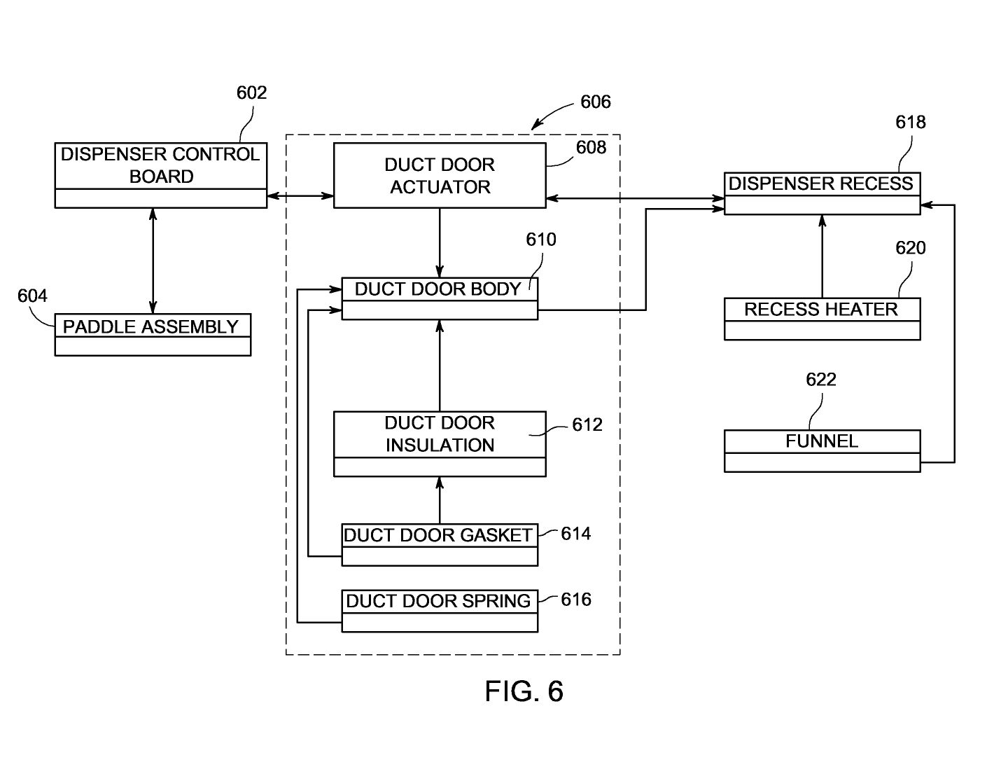

FIG. 7 is a block diagram of an example actuator assembly 702, according to an aspect of the invention. By way of illustration, actuator assembly 702 includes a shape memory alloy (SMA) compliance mechanism 704, a SMA slider 706, an actuator housing 708, a SMA wire 710, a crimp 712 and a lead wire 714 (an electrical lead not limited to a wire can also be used). The SMA compliance mechanism 704 and the SMA slider 706 rest in the actuator housing 708. The lead wire 714 is crimped by crimp 712, and the SMA wire 710 wraps around the actuator housing 708 and the SMA slider 706.

The SMA compliance mechanism 704 utilizes a spring with a large spring rate, which acts as a safety so that the wire is not stressed if a large outside force is applied to the SMA wire. SMA slider 706 provides an interface between the SMA wire 710 and crank pin on the duct door body 718 to guide movement by sliding in a linear direction. The slider can be inserted onto a crank pin coupled to the refrigerator duct door body. Actuator housing 708 protects the SMA wire 710 from moisture, contact, debris, impact, etc. Also, actuator housing 708 provides a track for the SMA slider 706, locates the compliance mechanism 704, and includes stand-offs to provide attachment locations for screws for the recess.

The SMA wire 710 heats and contracts under voltage to apply force to the slider 706. The crimp 712 provides robust mechanical and electrical attachment of the lead wire 714 to the SMA wire 710, and also restricts the SMA wire loop at a fixed position at the attachment point to the actuator housing 708. Additionally, the lead wire 714 provides current to the SMA wire 710.

FIG. 7 also depicts a dispenser recess 716, a duct door body 718 and a dispenser control board 720. As illustrated, the actuator housing 708 screws onto the dispenser recess 718, while the duct door body snaps into the recess. Further, the SMA slider 706 is inserted into the duct door body 718. The dispenser recess 716 provides attachment points for the duct door 718, the spring, the actuator 708 and a funnel, and also restricts the actuator base from rotating. The duct door body 718 provides alignment and a rotation axis for the duct door assembly, and also provides a lip for assembling a gasket. Additionally, the duct door body 718 contains and protects insulation, retains a spring in position, and transfers actuator force to torque through the duct door assembly.

The dispense control board 720 sends a signal to the actuator to begin, maintain and/or stop dispensing. The control board 720 also provides power and control to recess and duct door heaters, sends power to the switch/paddle and lead wire 714, and also receives a signal from the switch/paddle to initiate or stop dispensing.

One advantage that may be realized in the practice of some embodiments of the described apparatus and techniques is the use of an actuator that is smaller in size, lower in cost, and requires less power than existing approaches and systems.

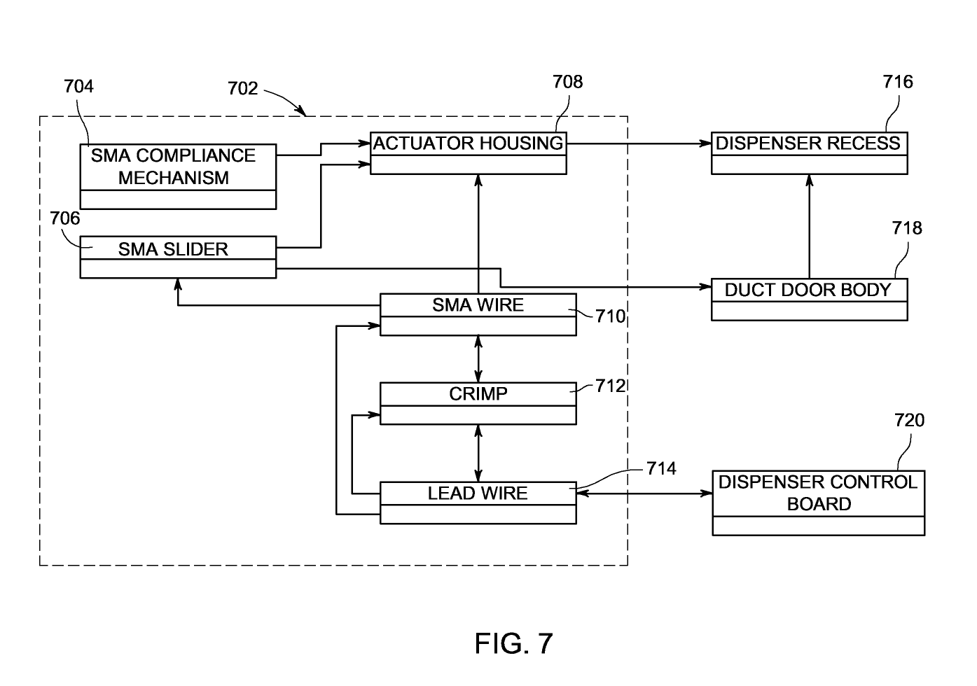

Reference should now be had to the flow chart of FIG. 8. FIG. 8 is a flow chart of a method for operating an example actuator, in accordance with a non-limiting aspect of the invention. Step 802 includes detecting that the paddle has been actuated when a signal is received that the switch is closed. Step 804 includes providing opening power/voltage to an actuator for an opening duration. With the opening voltage, the resistance in the SMA wire produces heat, taking the wire from a cold (expanded) to a hot (contracted) state. The opening duration allows the SMA wire to fully contract, causing the duct door to open.

Step 806 includes monitoring the switch for a change in status, showing a consumer has dispensed the desired amount of ice and released the paddle which opens the switch. If yes (the switch is closed), then step 808 includes providing holding power/voltage to the actuator to maintain the duct door being open (meaning, for example, that the consumer is still pressing a glass on/to the paddle). The holding voltage maintains the hot temperature of the wire. If no (the switch is not closed), then step 810 includes providing holding power/voltage to the actuator for a delay time, to allow falling ice to clear the duct door. By way of example, step 810 can indicate that the consumer has removed their glass/hand from the paddle, and the mechanism maintains the power or voltage for a pre-determined period of time to make sure that all of the dispensed ice has cleared the door. In the illustrative embodiments, a delay time on the order of two seconds has provided satisfactory results.

Further, step 812 includes removing any power to the actuator, the SMA expanding thereby causing the duct door to close. During this expanding period, the SMA cools and returns to its original position/length.

Accordingly, the techniques depicted in FIG. 8 can be implemented, for example, in an apparatus that includes a duct door rotatably mounted in relation to a refrigerator dispenser recess, a shape memory alloy wire coupled to the duct door (for example, via encircling the shape memory alloy wire about a duct door crank) such that the shape memory alloy wire causes the duct door to rotate, and an electrical lead connected to the shape memory alloy wire. As detailed herein, the shape memory alloy wire is capable of providing a linear displacement in response to an electrical signal from the electrical lead.

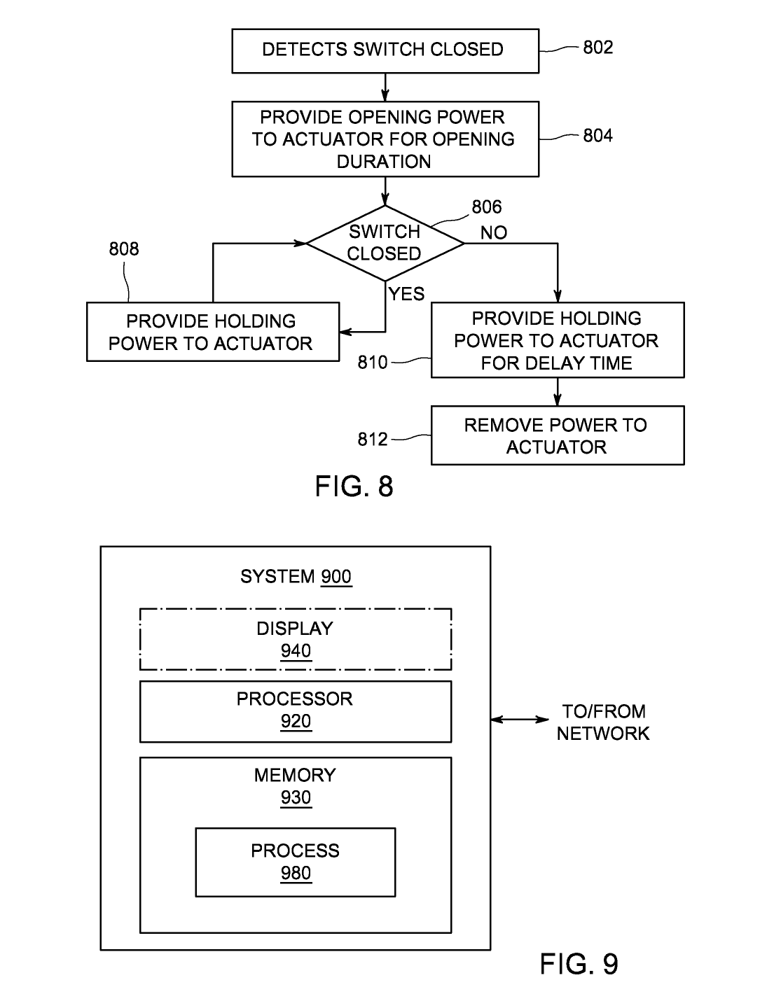

Aspects of the invention (for example, dispenser control board or a workstation or other computer system to carry out design methodologies) can employ hardware and/or hardware and software aspects. Software includes but is not limited to firmware, resident software, microcode, etc. FIG. 9 is a block diagram of a system 900 that can implement part or all of one or more aspects or processes of the invention. As shown in FIG. 9, memory 930 configures the processor 920 to implement one or more aspects of the methods, steps, and functions disclosed herein (collectively, shown as process 980 in FIG. 9). Different method steps could theoretically be performed by different processors. The memory 930 could be distributed or local and the processor 920 could be distributed or singular. The memory 930 could be implemented as an electrical, magnetic or optical memory, or any combination of these or other types of storage devices. It should be noted that if distributed processors are employed (for example, in a design process), each distributed processor that makes up processor 920 generally contains its own addressable memory space. It should also be noted that some or all of computer system 900 can be incorporated into an application-specific or general-use integrated circuit. For example, one or more method steps could be implemented in hardware in an application-specific integrated circuit (ASIC) rather than using firmware. Display 940 is representative of a variety of possible input/output devices.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a processor or other computer system, to carry out all or some of the steps to perform the methods or create the apparatuses discussed herein. A computer-usable medium may, in general, be a recordable medium (for example, floppy disks, hard drives, compact disks, EEPROMs, or memory cards) or may be a transmission medium (for example, a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). As used herein, a tangible computer-readable recordable storage medium is intended to encompass a recordable medium, examples of which are set forth above, but is not intended to encompass a transmission medium or disembodied signal.

Thus, elements of one or more embodiments of the invention, such as, for example, the dispenser control board, can make use of computer technology with appropriate instructions to implement method steps described herein.

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

It will be understood that processors or computers employed in some aspects may or may not include a display, keyboard, or other input/output components. In some cases, an interface is provided.

Thus, while there have shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An ice dispensing apparatus comprising:
a duct door rotatably mounted in relation to a dispenser recess; and
a shape memory alloy wire coupled to the duct door such that the shape memory alloy wire is operative when energized to cause the duct door to rotate.

2. The apparatus of claim 1, wherein the shape memory alloy wire is capable of providing a linear displacement in response to electrical energization.

3. The apparatus of claim 1, further comprising a duct door crank and wherein the shape memory alloy wire is mechanically coupled to the duct door crank.

4. The apparatus of claim 1, wherein the shape memory alloy wire comprises nitinol, nickel-titanium, copper, zinc, aluminum, nickel, gold, cadmium, iron, manganese, silicon, or a combination thereof.

5. The apparatus of claim 1, further comprising a shape memory alloy slider located in an actuator housing, wherein the actuator housing provides a track for the shape memory alloy slider, and wherein the shape memory alloy wire is mechanically coupled to the slider.

6. The apparatus of claim 5, wherein the actuator housing comprises at least one feature integrated for mechanical fastening to a mounting region to positively locate the actuator housing to the duct door.

7. The apparatus of claim 5, wherein energization of the shape memory alloy wire causes the shape memory alloy wire to contract and move the slider.

8. The apparatus of claim 5, wherein the slider is inserted onto a crank pin mechanically coupled to the duct door.

9. The apparatus of claim 8, wherein the crank pin is connected to the duct door via a crank and rotates the duct door when the slider is moved by the shape memory alloy wire.

10. The apparatus of claim 1, further comprising a biasing spring to provide a constant torque to hold the duct door in a closed position when ice is not being dispensed.

11. The apparatus of claim 1, wherein the duct door rotatably mounted for movement between a closed position sealed against the dispenser recess and an open position which permits ice to be dispensed, said wire being operatively linked to said door to move said door from its closed position to its open position when energized.

12. The apparatus of claim 1, further comprising a refrigerator dispenser control board, and wherein the dispenser control board controls energization of the wire.

13. The apparatus of claim 1, further comprising a source of electrical energy operatively coupled to the shape memory alloy wire for selectively energizing the wire.

14. A method comprising the steps of:
applying a voltage to a refrigerator duct door actuator in response to a first signal from a refrigerator dispenser switch to open the duct door, wherein the voltage heats a shape memory alloy wire in the duct door actuator, causing the shape memory alloy wire to contract in size, thereby causing the duct door to open; and
removing at least a portion of the voltage from the refrigerator duct door actuator in response to a second signal from the refrigerator dispenser switch to close the duct door, wherein the voltage removal allows the shape memory alloy wire to cool and expand in size, thereby causing the duct door to close.

15. The method of claim 14, further comprising applying a holding voltage to the refrigerator duct door actuator to maintain the duct door being open if the first signal from the refrigerator dispenser switch remains active.

16. The method of claim 15, wherein applying a holding voltage to the refrigerator duct door actuator to maintain the duct door being open comprises maintaining a temperature and length of the shape memory alloy wire to keep the duct door in the open position.

17. The method of claim 15, further comprising applying the holding voltage to the refrigerator duct door actuator for a determined delay time upon deactivation of the first signal from the refrigerator dispenser switch, wherein the delay time facilitates ice or water to pass through a chute of the duct door before the duct door closes.

18. The method of claim 14, further comprising monitoring the refrigerator dispenser switch for a change in status.
